(19) United States
(12) Patent Application Publication
(10) Pub. No.: US 2009/0078325 A1
(43) Pub. Date: Mar. 26, 2009

(54) Water outlet device for a plastic faucet

(76) Inventor: Ming-Shuan Lin, Taichung Hsien (TW)

Correspondence Address: GALLAGHER & LATHROP, A PROFESSIONAL CORPORATION, 601 CALIFORNIA ST, SUITE 1111, SAN FRANCISCO, CA, 94108, US

(21) Appl. No.: 11/903,532

(22) Filed: Sep. 21, 2007

(51) Int. Cl. F16K 23/00

(52) U.S. Cl. 137/801

(57) ABSTRACT

A water outlet device includes a first pipe component having opposite first and second end portions and a first internal wall surface, a second pipe component having a third end portion and a second external wall surface, and a leakproofing component clamped between the pipe components. One of the first and third end portions is formed with a plurality of slits for imparting resiliency thereto in radial directions. One of the first internal wall surface at the first end portion and the second external wall surface at the second end portion is formed with an engaging hole, and the other one is formed with an engaging protrusion having an inclined guide surface. The third end portion is insertable fittingly into the first end portion to engage the engaging protrusion in the engaging hole. At least one of the first and second pipe components is an angled pipe component.

### BACKGROUND OF THE INVENTION

1. Field of the Invention

The invention relates to a tapware, more particularly to a water outlet device for a plastic faucet.

2. Description of the Related Art

As shown in FIG. 1, a plastic faucet includes a conventional water outlet device 1 and a housing 2 enclosing the conventional water outlet device 1. The conventional water outlet device 1 includes a plastic first component 101, and a plastic second component 102 coupled to the first component 101. The first component 101 is formed with a first water passage 103 therein, a cold water hole 104, and a hot water hole 105. The first component 101 is further formed with a flange 106 at one end for coupling to the second component 102. The second component 102 is formed with a second water passage 107 fluidly communicating with the first water passage 103, and a recess 108 for coupling with the flange 106.

Since the entire passage in the conventional water outlet device 1, including the first and second passages 103, 107 has multiple bend segments, the plastic faucet has to be made by molding two components 101, 102 instead of one to facilitate release of the components 101, 102 from corresponding molds, followed by adhesively bonding together the components 101, 102 at the recess 10 8and the flange 106, thereby resulting in a relatively complicated manufacturing process. Moreover, water may leak from where the flange 106 is coupled to the recess 108 while flowing through the first and second passage 103, 107.

### SUMMARY OF THE INVENTION

Therefore, the object of the present invention is to provide a water outlet device that can be assembled easily and that can avoid water leakage. Accordingly, a water outlet device of the present invention for a plastic faucet comprises a first pipe component, a second pipe component, and a leakproofing component. The first pipe component is made of plastic and has a first end portion having a first open end, a second end portion disposed opposite to the first end portion and having a second open end, and a first internal wall surface extending from the first end portion to the second end portion and defining a first pipe hole. The second pipe component is made of plastic and has a third end portion having a third open end, a fourth end portion disposed opposite to the third end portion and having a fourth open end, a second internal wall surface extending from the third end portion to the fourth end portion and defining a second pipe hole, and a second external wall surface disposed opposite to the second internal wall surface. One of the first end portion and the third end portion is formed with a plurality of first slits imparting resiliency to the one of the first end portion and the third end portion in radial directions. One of the first internal wall surface at the first end portion and the second external wall surface at the third end portion is formed with a radial first engaging hole spaced apart angularly from the first slits, and the other one of the first internal wall surface at the first end portion and the second external wall surface at the third end portion is formed with a radial first engaging protrusion that has a first inclined guide surface. The third end portion is insertable fittingly into the first end portion through guidance of the first inclined guide surface of the first engaging protrusion and resiliency of the one of the first end portion and the third end portion to engage the first engaging protrusion in the first engaging hole. The leakproofing component is clamped between the first internal wall surface at the first end portion and the second external wall surface at the third end portion. At least one of the first and second pipe components is an angled pipe component.

### BRIEF DESCRIPTION OF THE DRAWINGS

Other features and advantages of the present invention will become apparent in the following detailed description of the preferred embodiment with reference to the accompanying drawings, of which:

FIG. 1 is an assembled sectional view of a plastic faucet having a conventional water outlet device;

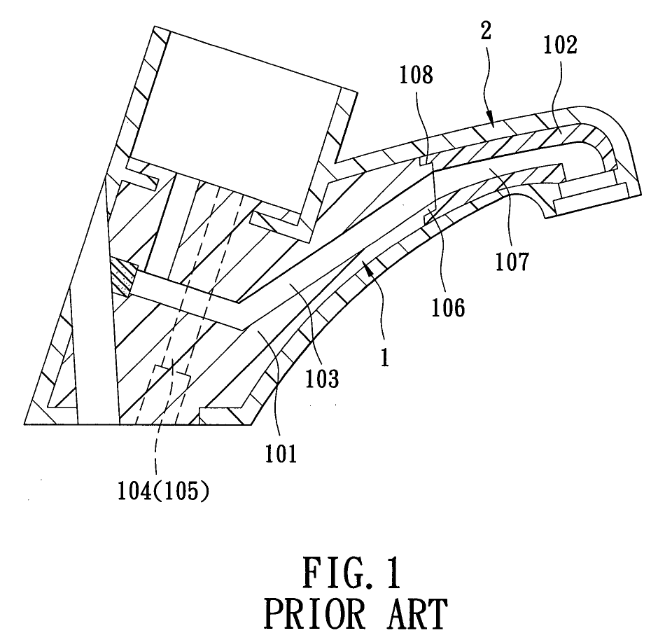

FIG. 2 is an assembled schematic partly sectional view of a plastic faucet that incorporates a preferred embodiment of a water outlet device according to the invention;

FIG. 3 is an assembled sectional view of the preferred embodiment taken along line III-III in FIG. 2;

FIG. 4 is a fragmentary exploded perspective view of the preferred embodiment; and

FIG. 5 is a fragmentary assembled sectional view of the preferred embodiment.

### DETAILED DESCRIPTION OF THE PREFERRED EMBODIMENT

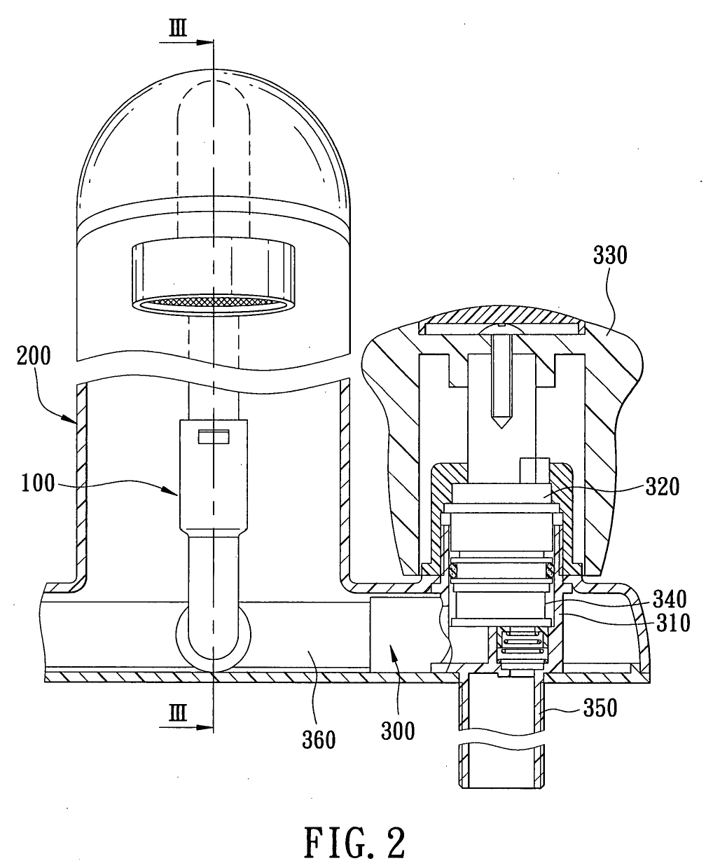

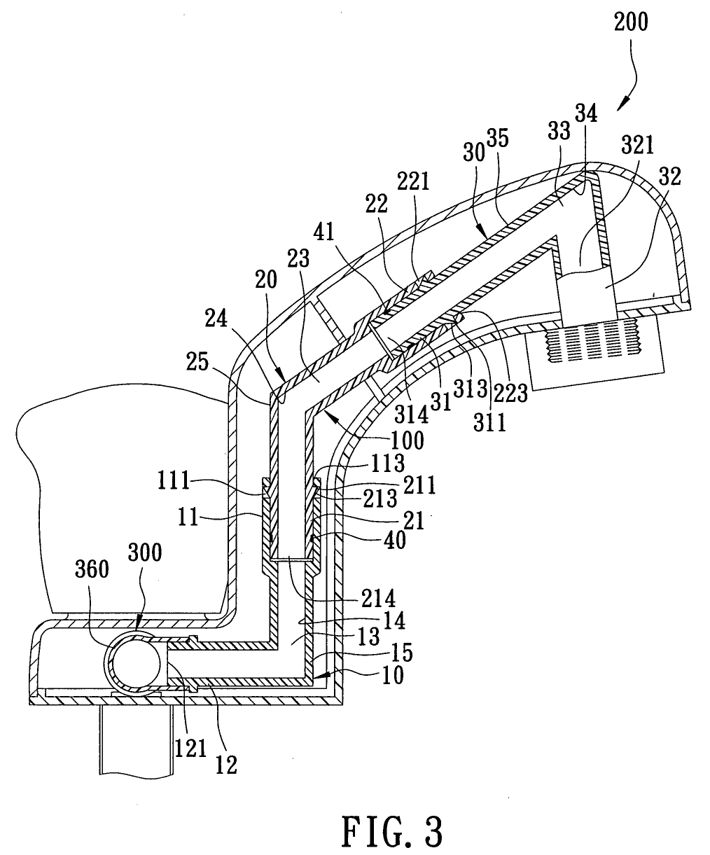

As shown in FIGS. 2 and 3, the preferred embodiment of a water outlet device 100 according to the present invention is adapted to be enclosed within a plastic housing 200, is adapted to be connected to a water inlet controller 300, and comprises a first pipe component 10, a second pipe component 20, a third pipe component 30, and first and second leakproofing components 40, 41. The water inlet controller 300 includes a valve seat 310, a valve body 320 disposed in the valve seat 310, and a control handle 330 for controlling rotation of the valve body 320 relative to the valve seat 310. The valve seat 310 has a valve space 340 for receiving the valve body 320, a water inlet pipe 350 that extends from the valve space 340, that extends outwardly of the housing 200, and through which water flows into the valve space 340, and a water supply pipe 360 that is connected to the water outlet device 100.

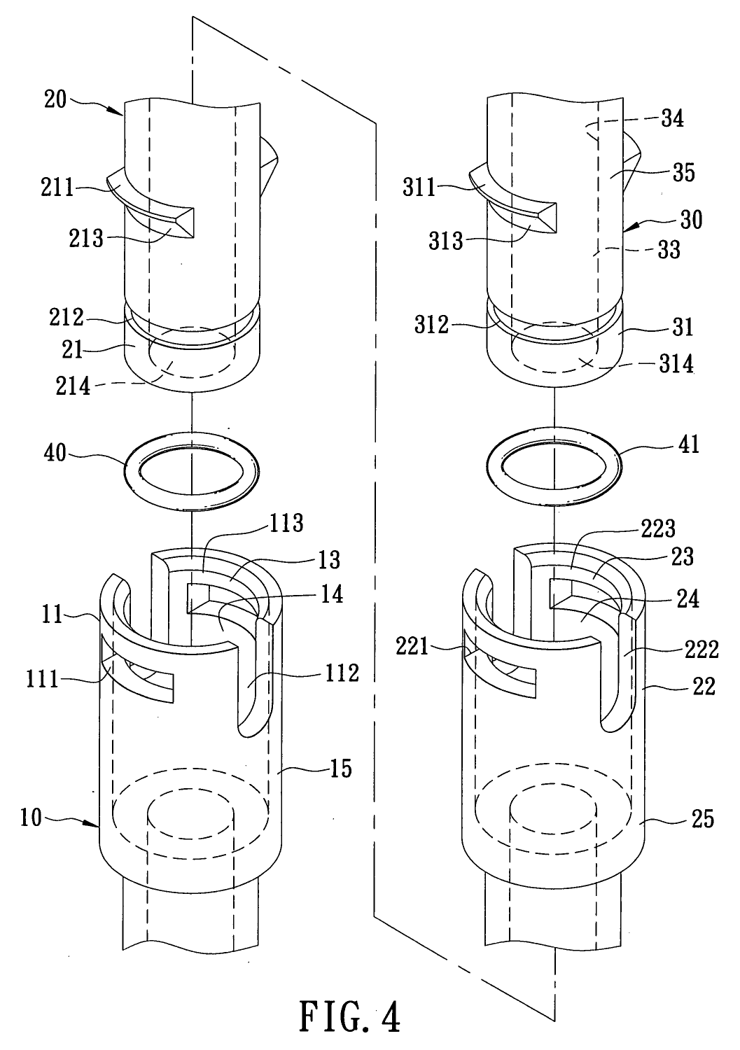

As shown in FIGS. 2 to 5, the first pipe component 10 in the preferred embodiment is made of plastic and has a first end portion 11 that has a first open end 113, a second end portion 12 that is disposed opposite to the first end portion 11, that is adapted to be coupled to the water supply pipe 360, and that has a second open end 121, a first internal wall surface 14 that extends from the first end portion 11 to the second end portion 12 and that defines a first pipe hole 13, and a first external wall surface 15 that is disposed opposite to the first internal wall surface 14. In this embodiment, the first end portion 11 is formed with a pair of first slits 112 that extend parallel to an axis of the first pipe component 10 and that impart resiliency to the first end portion 11 in radial directions. In addition, in this embodiment, the first internal wall surface 14 at the first end portion 11 is formed with a pair of radial first engaging holes 111 that alternate with the first slits 112. Each of the first engaging holes 111 is a through hole extending from the first internal wall surface 14 to the first external wall surface 15. The first pipe component 10 is L-shaped in this embodiment, i.e., the first pipe component 10 is a right-angled pipe component.

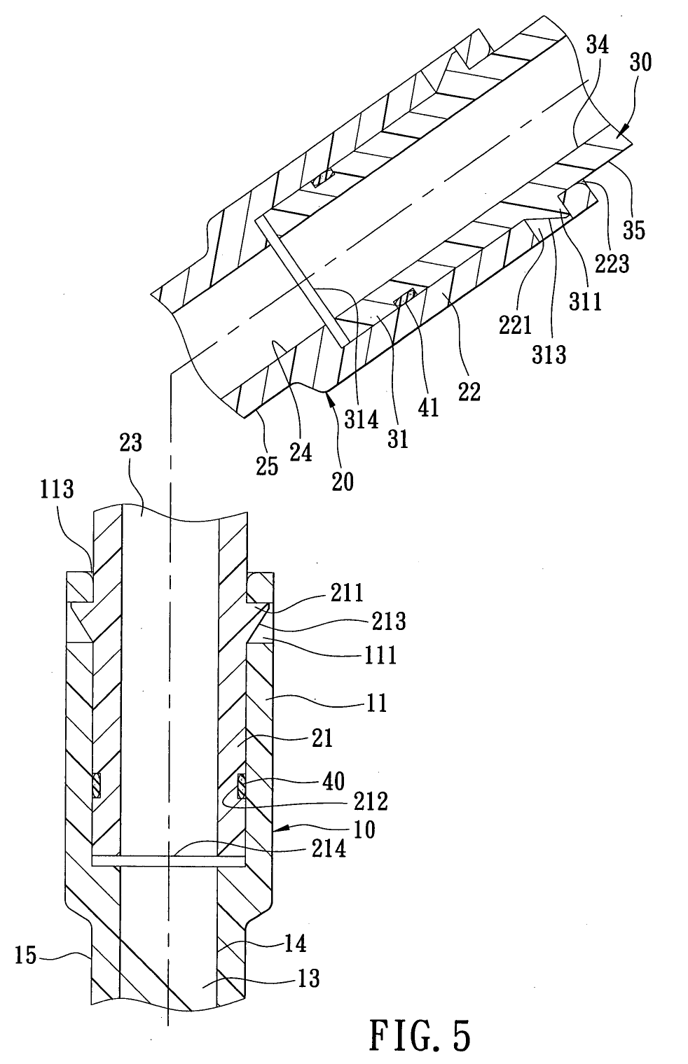

The second pipe component 20 is made of plastic and has a third end portion 21 that is insertable fittingly into the first end portion 11 of the first component 10 and that has a third open end 214, a fourth end portion 22 that is disposed opposite to the third end portion 21 and that has a fourth open end 223, a second internal wall surface 24 that extends from the third end portion 21 to the fourth end portion 22 and that defines a second pipe hole 23, and a second external wall surface 25 disposed opposite to the second internal wall surface 24. In this embodiment, the second external wall surface 25 at the third end portion 21 is formed with a pair of radial first engaging protrusions 211, each of which is formed with a first inclined guide surface 213. The second external wall surface 25 at the third end portion 21 is further formed with a first annular groove 212 between the first engaging protrusions 211 and the third open end 214. In this embodiment, the fourth end portion 22 is formed with a pair of second slits 222 that extend parallel to an axis of the second pipe component 20 and that impart resiliency to the fourth end portion 22 in radial directions. In addition, in this embodiment, the second internal wall surface 24 at the fourth end portion 22 is formed with a pair of radial second engaging holes 221 that alternate with the second slits 222. Each of the second engaging holes 221 is a through hole extending from the second internal wall surface 24 to the second external wall surface 25. As shown in FIGS. 3 and 5, the second pipe component 20 is an obtuse-angled pipe component in this embodiment.

The third pipe component 30 is made of plastic and has a fifth end portion 31 that is insertable fittingly into the fourth end portion 22 of the second pipe component 20 and that has a fifth open end 314, a sixth end portion 32 that is disposed opposite to the fifth end portion 31 and that has a sixth open end 321, a third internal wall surface 34 that extends from the fifth end portion 31 to the sixth end portion 32 and that defines a third pipe hole 33, and a third external wall surface 35 disposed opposite to the third internal wall surface 34. In this embodiment, the third external wall surface 35 at the fifth end portion 31 is formed with a pair of radial second engaging protrusions 311, each of which is formed with a second inclined guide surface 313. The third external wall surface 35 at the fifth end portion 31 is further formed with a second annular groove 312 between the second engaging protrusions 311 and the fifth open end 314. In this embodiment, the third pipe component 30 is an acute-angled pipe component (see FIG. 3). The first leakproofing component 40 is retained in the first annular groove 212 in the third end portion 21 of the second pipe component 20 and is clamped between the first internal wall surface 14 of the first pipe component 10 at the first end portion 11 and the second external wall surface 25 of the second pipe component 20 at the third end portion 21 without spanning transversely the first slits 112 in the first end portion 11 when the third end portion 21 is inserted fittingly into the first end portion 11. The second leakproofing component 41 is retained in the second annular groove 312 in the fifth end portion 31 of the third pipe component 30 and is clamped between the second internal wall surface 24 of the second pipe component 20 at the fourth end portion 22 and the third external wall surface 35 of the third pipe component 30 at the fifth end portion 31 without spanning transversely the second slits 222 in the fourth end portion 22 when the fifth end portion 35 is inserted fittingly into the fourth end portion 22.

As shown in FIGS. 3 and 5, when assembling the water outlet device 100 of this invention, the third end portion 21 of the second pipe component 20 is inserted fittingly into the first end portion 11 of the first pipe component 10 through guidance of the first inclined guide surface 213 of each of the first engaging protrusions 211 and resiliency of the first end portion 11 to engage the first engaging protrusions 211 in the first engaging holes 111 in the first end portion 11, thereby coupling the first pipe component 10 and the second pipe component 20 together. Then, the fifth end portion 31 of the third pipe component 30 is inserted fittingly into the fourth end portion 22 of the second pipe component 20 through guidance of the second inclined guide surface 313 of each of the second engaging protrusions 311 of the fifth end portion 31 and resiliency of the fourth end portion 22 to engage the second engaging protrusions 311 in the second engaging holes 221 in the fourth end portion 22, thereby coupling the second pipe component 20 and the third pipe component 30 together. Therefore, the water outlet device 100 can be assembled easily without using adhesive to form a water passage having multiple bend segments, and the first and second leakproofing components 40, 41 are provided to avoid water leakage while water is flowing through the first pipe component 10, the second pipe component 20, and the third pipe component 30.

It should be noted that, the locations of the first engaging holes 111 and the first engaging protrusions 211, as well as the second engaging holes 221 and the second engaging protrusions 311, can be interchanged in other embodiments of this invention. In addition, the first slits 112 may be formed at the third end portion 21 of the second pipe component 20 in other embodiments of this invention for imparting resiliency to the third end portion 21 in radial directions so as to facilitate the coupling between the first pipe component 10 and the second pipe component 20. Similarly, the second slits 222 may be formed at the fifth end portion 31 of the third pipe component 30 for imparting resiliency to the fifth end portion 31 in radial directions so as to facilitate the coupling between the second pipe component 20 and the third pipe component 30. Moreover, the first annular groove 212 may be formed at the first internal wall surface 14 of the first pipe component 10 at the first end portion 11 in other embodiments of this invention for retaining the first leakproofing component 40. Similarly, the second annular groove 312 may be formed at the second internal wall surface 24 of the second pipe component 20 at the fourth end portion 22 in other embodiments of this invention for retaining the second leakproofing component 41. Furthermore, while this embodiment is exemplified using a pair of first engaging holes 111 corresponding to a pair of first engaging protrusions 211, as well as a pair of second engaging holes 221 corresponding to a pair of second engaging protrusions 311, only one first engaging hole 111 corresponding to one first engaging protrusion 211, as well as only one second engaging hole 221 corresponding to one second engaging protrusion 311 may be employed in other embodiments of this invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A water outlet device for a plastic faucet, said water outlet device comprising:
a first pipe component made of plastic and having a first end portion that has a first open end, a second end portion that is disposed opposite to said first end portion and that has a second open end, and a first internal wall surface that extends from said first end portion to said second end portion and that defines a first pipe hole;
a second pipe component made of plastic and having a third end portion that has a third open end, a fourth end portion that is disposed opposite to said third end portion and that has a fourth open end, a second internal wall surface that extends from said third end portion to said fourth end portion and that defines a second pipe hole, and a second external wall surface disposed opposite to said second internal wall surface;
one of said first end portion and said third end portion being formed with a plurality of first slits that impart resiliency to said one of said first end portion and said third end portion in radial directions;
one of said first internal wall surface at said first end portion and said second external wall surface at said third end portion being formed with a radial first engaging hole that is spaced apart angularly from said first slits, and the other one of said first internal wall surface at said first end portion and said second external wall surface at said third end portion being formed with a radial first engaging protrusion that has a first inclined guide surface;
said third end portion being insertable fittingly into said first end portion through guidance of said first inclined guide surface of said first engaging protrusion and resiliency of said one of said first end portion and said third end portion to engage said first engaging protrusion in said first engaging hole; and
a first leakproofing component clamped between said first internal wall surface at said first end portion and said second external wall surface at said third end portion;
wherein at least one of said first and second pipe components is an angled pipe component.

2. The water outlet device as claimed in claim 1, further comprising:
an angled third pipe component made of plastic and having a fifth end portion that has a fifth open end, a sixth end portion that is disposed opposite to said fifth end portion and that has a sixth open end, a third internal wall surface that extends from said fifth end portion to said sixth end portion and that defines a third pipe hole, and a third external wall surface that is disposed opposite to said third internal wall surface; and
a second leakproofing component clamped between said second internal wall surface at said fourth end portion and said third external wall surface at said fifth end portion.

3. The water outlet device as claimed in claim 2, wherein:
one of said fourth end portion of said second pipe component and said fifth end portion of said third pipe component is formed with a plurality of second slits that impart resiliency to said one of said fourth end portion and said fifth end portion in radial directions;
one of said second internal wall surface at said fourth end portion and said third external wall surface at said fifth end portion is formed with a radial second engaging hole that is spaced apart angularly from said second slits, and the other one of said second internal wall surface at said fourth end portion and said third external wall surface at said fifth end portion is formed with a radial second engaging protrusion that has a second inclined guide surface;
said fifth end portion is insertable fittingly into said fourth end portion through guidance of said second inclined guide surface of said second engaging protrusion and resiliency of said one of said fourth end portion and said fifth end portion to engage said second engaging protrusion in said second engaging hole.

4. A plastic faucet comprising a plastic housing and a water outlet device enclosed within said plastic housing, said water outlet device including:
a first pipe component made of plastic and having a first end portion that has a first open end, a second end portion that is disposed opposite to said first end portion and that has a second open end, and a first internal wall surface that extends from said first end portion to said second end portion and that defines a first pipe hole;
a second pipe component made of plastic and having a third end portion that has a third open end, a fourth end portion that is disposed opposite to said third end portion and that has a fourth open end, a second internal wall surface that extends from said third end portion to said fourth end portion and that defines a second pipe hole, and a second external wall surface disposed opposite to said second internal wall surface;
one of said first end portion and said third end portion being formed with a plurality of first slits that impart resiliency to said one of said first end portion and said third end portion in radial directions;
one of said first internal wall surface at said first end portion and said second external wall surface at said third end portion being formed with a radial first engaging hole that is spaced apart angularly from said first slits, and the other one of said first internal wall surface at said first end portion and said second external wall surface at said third end portion being formed with a radial first engaging protrusion that has a first inclined guide surface;
said third end portion being insertable fittingly into said first end portion through guidance of said first inclined guide surface of said first engaging protrusion and resiliency of said one of said first end portion and said third end portion to engage said first engaging protrusion in said first engaging hole; and
a first leakproofing component clamped between said first internal wall surface at said first end portion and said second external wall surface at said third end portion;
wherein at least one of said first and second pipe components is an angled pipe component.
